(19) United States
(12) Patent Application Publication
(10) Pub. No.: US 2004/0105591 A1
(43) Pub. Date: Jun. 3, 2004

(54) Method and apparatus for moving picture coding

(75) Inventors: Yoshimasa Honda, Kamakura-shi (JP); Tsutomu Uenoyama, Kawasaki-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/679,482

(22) Filed: Oct. 7, 2003

(30) Foreign Application Priority Data
Oct. 9, 2002 (JP) 2002-295620

(51) Int. Cl. G06K 9/36; G06K 9/46

(52) U.S. Cl. 382/240; 382/243

(57) ABSTRACT

A moving picture coding method capable of maintaining high picture quality for an important area even in a low bit rate and gradually improving picture quality of the neighboring area as the bit rate becomes higher. According to this method, the important area detection section 122 automatically detects an important area within a frame, the gradual shift map generation section 124 generates a gradual shift map whose shift value decreases gradually from the important area toward the neighboring area. The bit shift section 130 bit-shifts DCT coefficients according to the gradual shift map. In this way, more DCT coefficients which contribute to improvement of picture quality of the important area are stored in the start portion of the enhancement layer preferentially.

### BACKGROUND OF THE INVENTION

1. Field of the Invention

The present invention relates to a moving picture coding method and moving picture coding apparatus having a hierarchic data structure, and more particularly, to a moving picture coding method and moving picture coding apparatus capable of keeping high picture quality for an important area on a frame even in a low bit rate.

2. Description of the Related Art

Picture data transmitted in a conventional picture transmission system is normally compressed/coded to a certain bit rate or below according to a H.261 system or MPEG (Moving Picture Experts Group) system, etc., and picture quality of picture data once coded cannot be changed even if the transmission bit rate changes.

However, with convergence of various type of networks in recent years, hence large bit rate variations in the transmission path, there is a demand for picture data capable of transmitting pictures whose quality can match a plurality of bit rates and in response to this demand a hierarchic coding system having a hierarchic structure and applicable to a plurality of bit rates is standardized. MPEG-4 FGS (ISO/IEC 14496-2 Amendment 2:2001), which is a system having a high degree of freedom particularly with respect to bit rate selection among such hierarchic coding systems, is currently being standardized. Picture data coded according to MPEG-4 FGS consists of one base layer which is a moving picture stream which can be decoded singly and at least one enhancement layer which is a moving picture stream to improve quality of the decoded moving picture of the base layer. The base layer is picture data which has low picture quality in a low bit rate and adding the enhancement layer to this base layer according to the bit rate achieves high picture quality with a high degree of freedom.

Since MPEG-4 FGS features the ability to divide total data of the enhancement layer to be added to the base layer into portions of any desired size by controlling the number of enhancement layers to be assigned, MPEG-4 FGS can control the total data size of the enhancement layer with the bit rate of the base layer fixed and adapt it to the transmission bit rate. For example, by selecting and receiving a base layer and a plurality of enhancement layers according to the receivable bit rate, it is possible to receive a picture of the quality corresponding to the bit rate. Furthermore, even if the enhancement layers are lost in the transmission path, it is possible to reconstruct the picture with only the base layer though its picture quality is low.

Thus, by adding a larger enhancement layer or more enhancement layers to the base layer as the bit rate becomes higher, MPEG-4 FGS can improve the picture quality of an entire frame smoothly but the picture quality of the entire frame naturally deteriorates in a situation of a low bit rate. An MPEG-4 FGS enhancement layer in particular uses an intra-frame coding system which does not use a correlation between temporally-continuous frames, and therefore its compression efficiency decreases compared to inter-frame coding which uses a correlation between frames. There is a problem that the picture quality of even an area important to a user becomes low in a low bit rate in particular.

Thus, a conventional technology for improving coding efficiency of enhancement layers performs coding on macro blocks in descending order of quantized values used in a base layer instead of performing coding sequentially from the upper left to lower right in a bit plane VLC (Variable Length Coding) of enhancement layers (e.g., see Unexamined Japanese Patent Publication No.2001-268568).

FIG. 1 illustrates a configuration example of a conventional picture coding apparatus. This picture coding apparatus 10 comprises a picture input section 12, a base layer coding section 14, a base layer decoding section 16, a base layer output section 18, a residual picture generation section 20, a DCT section 22, a storage order control section 24, a bit plane VLC section 26 and an enhancement layer output section 28.

The picture input section 12 outputs an input picture signal for each frame to the base layer coding section 14 and the residual picture generation section 20. The base layer coding section 14 performs MPEG coding using motion compensation, DCT (Discrete Cosine Transform) or quantization on the picture signal input from the picture input section 12, outputs coded data to the base layer output section 18 and the base layer decoding section 16 and at the same time outputs the quantized value used for quantization of a macro block made up of 16×16 pixels (tetragonal lattice-shaped pixel set consisting of 16×16 pixels) to the storage order control section 24. The base layer decoding section 16 outputs the decoded data obtained through inverse quantization, inverse DCT or motion compensation on the coded data of the base layer to the residual picture generation section 20.

The residual picture generation section 20 performs residual processing between the non-compressed picture signal input from the picture input section 12 and decoded picture data after base layer coding/decoding input from the base layer decoding section 16, generates a residual picture and outputs the residual picture to the DCT section 22. The DCT section 22 performs DCT transforms on the entire residual picture input from the residual picture generation section 20 sequentially in units of 8×8 pixels and outputs all DCT coefficients in the picture to the storage order control section 24. The storage order control section 24 sorts all the DCT coefficients input from the DCT section 22 in units of macro blocks, outputs macro block storage order information to the enhancement layer output section 28 and at the same time outputs all the sorted DCT coefficients to the bit plane VLC section 26.

The sorting of macro blocks by the storage order control section 24 is performed using quantized values for each macro block input from the base layer coding section 14 and macro blocks are stored in descending order of quantized values from the upper left to the lower right. The bit plane VLC section 26 transform each of the DCT coefficients of the full frame input from the storage order control section 24 into binary numbers, constructs a bit plane using bits belonging to their respective bit positions and performs variable length coding (VLC) in the order from higher bit planes to lower bit planes. In each bit plane, the bit plane VLC section 26 performs variable length coding (VLC) on macro blocks at the upper left to the lower right, arranges them from the start in a bit stream sequentially from higher bit planes, generates an enhancement layer bit stream and outputs it to the enhancement layer output section 28. The bit stream of the enhancement layer generated by the bit plane VLC section 26 has a structure in which the data on higher bit planes is stored at the start followed by the data on lower bit planes and data of a macro block with large quantized values is stored in each bit plane first. The enhancement layer output section 28 multiplexes the macro block storage order information with the enhancement layer bit stream and outputs it to each section.

Thus, the picture coding apparatus 10 performs bit plane VLC processing on macro blocks in descending order of their quantized values on each bit plane, and can thereby store data as an enhancement layer for a macro block whose quantization error on each bit plane is estimated to be large first. Therefore, an area of a base layer whose picture quality deterioration is likely to become a great deal is stored in a higher enhancement layer in each bit plane, and therefore it is possible to improve the picture quality of an area whose picture quality deterioration is large first in such a low bit rate that uses only higher enhancement layers compared within the same bit plane.

However, when the order of macro block storage is changed within a bit plane, the conventional moving picture coding method can improve picture quality of a macro block whose picture quality deterioration is large first when the interior of each bit plane is viewed, but there is no difference in picture quality for each macro block when compared in units of bit plane. That is, there is no merit in a situation in which a picture is received with an enhancement layer divided for each bit plane.

It is preferable in a low bit rate in particular that the picture quality of an area important to the user be improved preferentially. When quantized values other than those of the important area are greater, picture quality of areas other than the important area is improved preferentially. The conventional method changes the coding order using quantized values and cannot improve picture quality of an important area in a low bit rate preferentially. Even if the data storage order within a bit plane is changed for the important area using the conventional method, this can only give local prioritization within the same limited bit plane.

Therefore, the conventional picture coding method cannot improve picture quality in the important area preferentially when the bit rate is low, not within the same limited bit plane. For this reason, the more important an area in a low bit rate is, the higher picture quality is demanded strongly for a picture coding system today.

### SUMMARY OF THE INVENTION

It is an object of the present invention to provide a moving picture coding method and moving picture coding apparatus capable of providing high quality in an important area even in a low bit rate and gradually improving picture quality of neighboring areas as the bit rate becomes higher.

An essential feature of the present invention is to carry out enhancement layer coding from an important area first and thereby keep high the quality of the important area even when the bit rate is lowered while a moving picture receiving terminal is moving.

According to an aspect of the invention, a moving picture coding method, which performs coding by dividing a moving picture into one base layer and at least one enhancement layer, comprises an extracting step of extracting the degree of importance of each area of the moving picture, and an assigning step of assigning coded data of each area to the enhancement layers in descending order of the degree of importance of the areas.

According to another aspect of the invention, a moving picture coding apparatus comprises a picture input section that inputs an original moving picture, a base layer coding section that extracts one base layer from the original moving picture and codes the base layer, a base layer decoding section that decodes the base layer coded by the base layer coding section and reconstructs the base layer, a residual picture generation section that generates a residual picture between the reconstructed picture reconstructed by the base layer decoding section and the original moving picture, an important area detection section that detects an important area from the original moving picture, a gradual shift map generation section that sets bit shift values gradually according to the degree of importance of the important area extracted by the important area detection section, a DCT section that DCT-transforms the residual picture generated by the residual picture generation section, a bit shift section that bit-shifts the DCT coefficient obtained by the DCT section by the bit shift value obtained by the gradual shift map generation section, a bit plane VLC section that performs VLC processing for each bit plane bit-shifted by the bit shift section, and an enhancement layer division section that divides the moving picture stream VLC-processed by the bit plane VLC section as an enhancement layer into at least one portion.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 illustrates a configuration example of a conventional picture coding apparatus;

FIG. 2 is a block diagram showing a configuration of a picture coding apparatus to which a moving picture coding method according to Embodiment 1 of the present invention is applied;

FIG. 3 is a block diagram showing a configuration of a picture decoding apparatus to which the moving picture coding method according to Embodiment 1 of the present invention is applied;

FIG. 4 is a flow chart showing an operation of the picture coding apparatus corresponding to Embodiment 1;

FIG. 5 illustrates an example of a detection result of the important area detection section in FIG. 2;

FIG. 6 illustrates an example of a gradual shift map;

FIG. 7 illustrates an example of the procedure for the gradual shift map generation process in FIG. 4;

FIG. 8A illustrates an example of bit shifts and shows a gradual shift map in particular;

FIG. 8B illustrates an example of bit shifts and shows DCT coefficients of MB1 in particular;

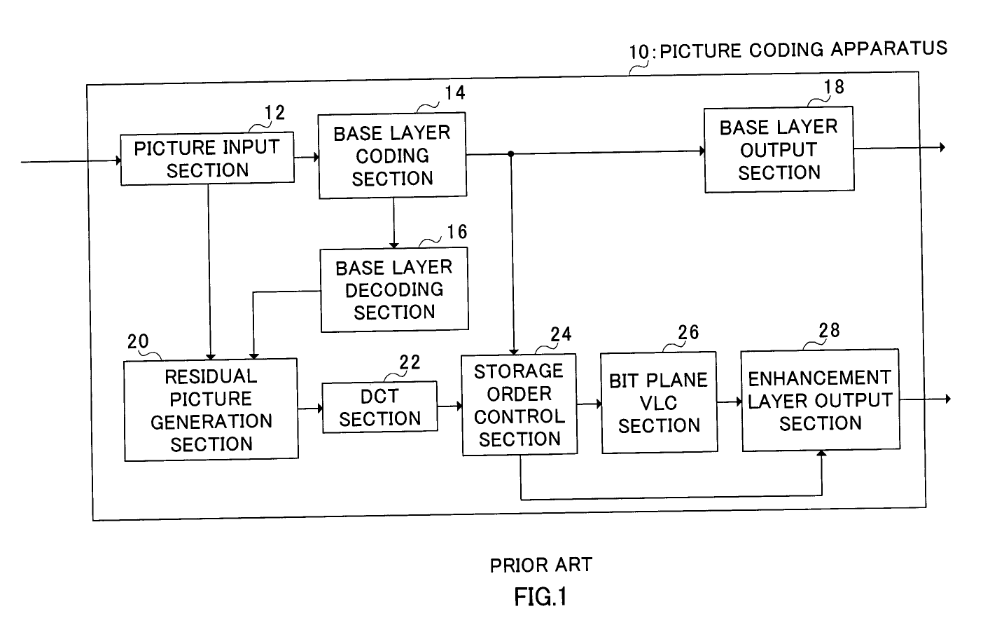

FIG. 5C illustrates an example of bit shifts and is a conceptual diagram of a bit plane before a shift in particular;

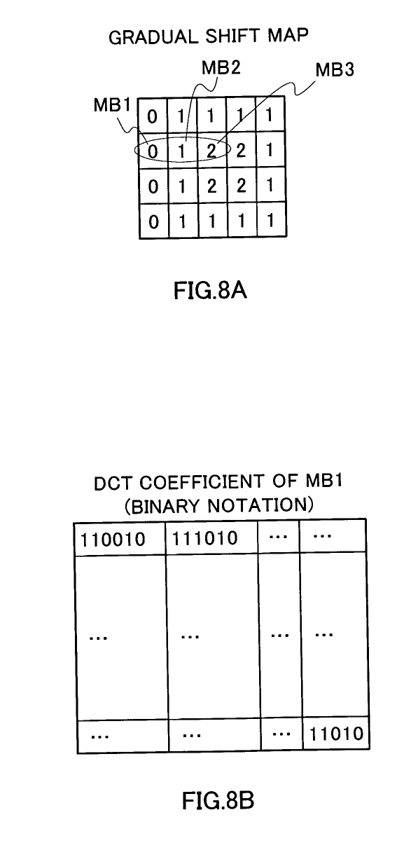

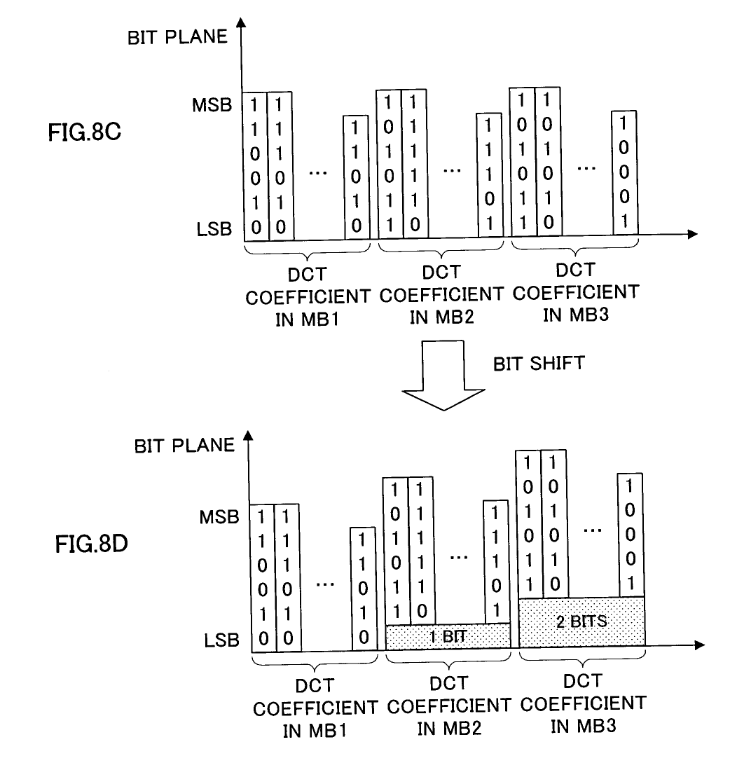

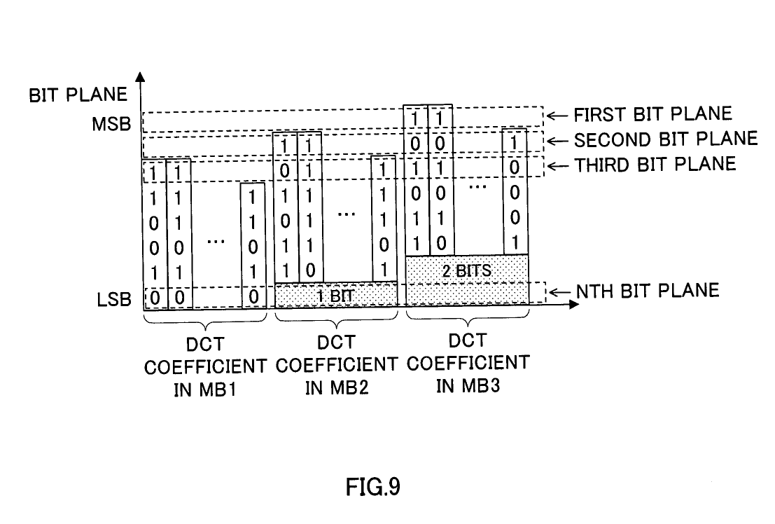

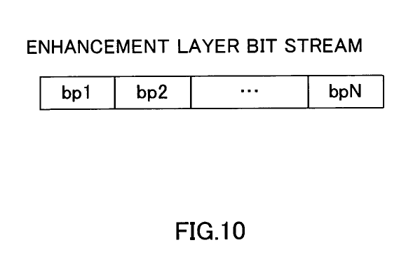

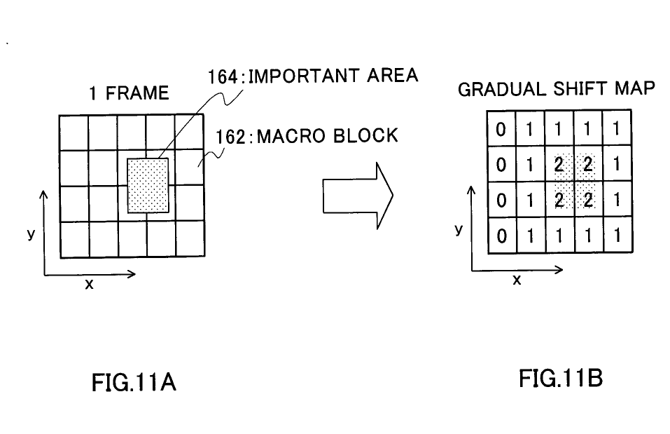

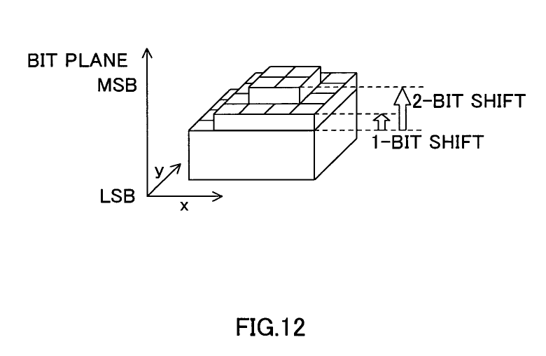

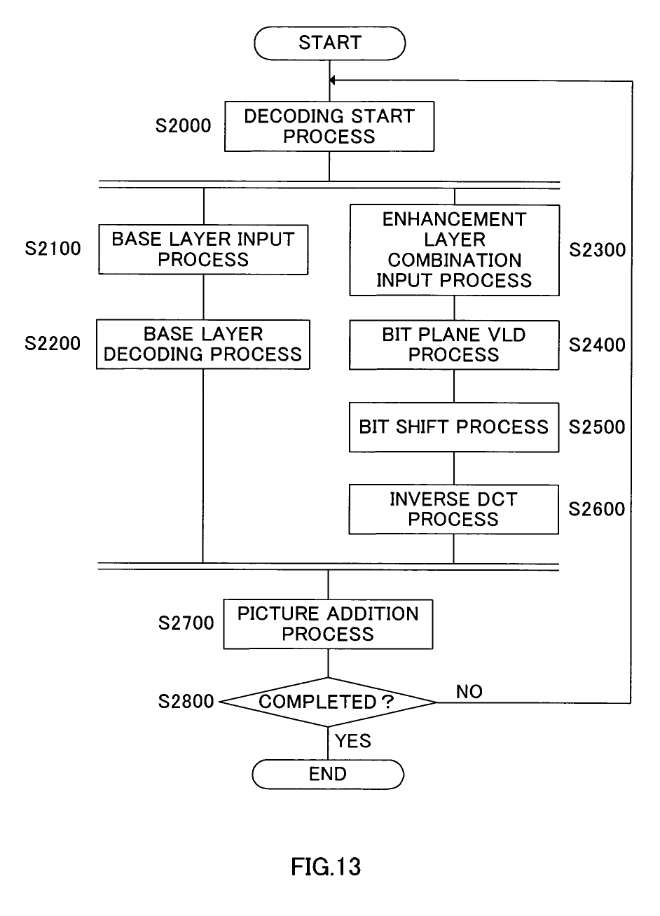

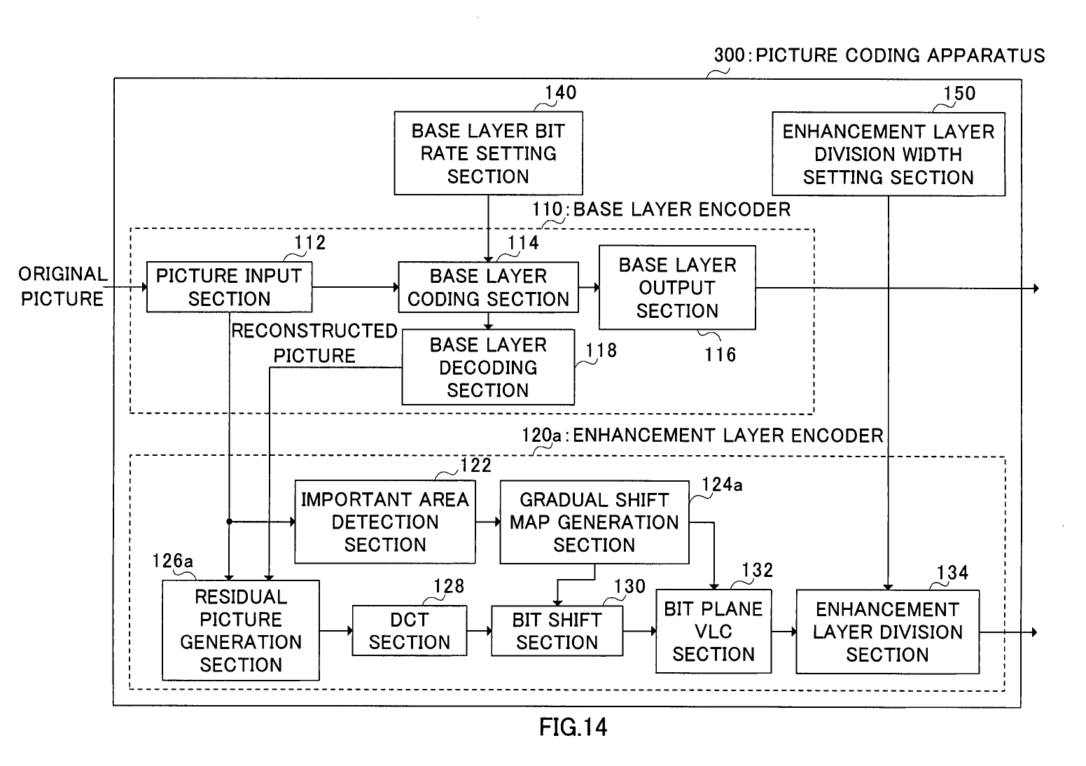

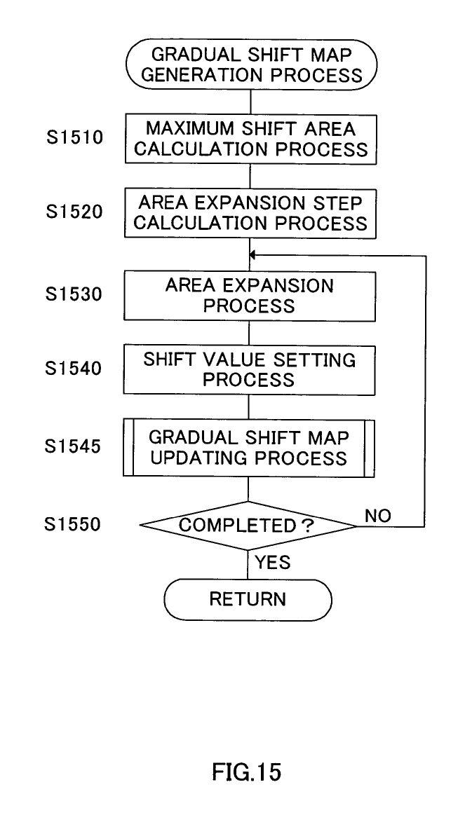

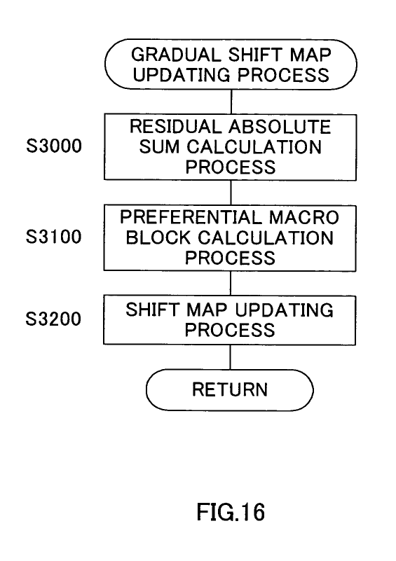

FIG. 8D illustrates an example of bit shifts and is a conceptual diagram of a bit plane after a shift in particular;

FIG. 9 is a conceptual diagram of a bit plane VLC;

FIG. 10 is a configuration diagram of an enhancement layer bit stream;

FIG. 11A illustrates an example of a result of detection of an important area;

FIG. 11B illustrates an example of a gradual shift map corresponding to the detection result in FIG. 11A;

FIG. 12 illustrates an example of the bit shift result corresponding to the detection result in FIG. 11A;

FIG. 13 is a flow chart showing an operation of the picture decoding apparatus corresponding to Embodiment 1;

FIG. 14 is a block diagram showing a configuration of a picture coding apparatus to which a moving picture coding method according to Embodiment 2 of the present invention is applied;

FIG. 15 is a flow chart showing an example of a procedure for the gradual shift map generation process in the gradual shift map generation section in FIG. 14; and

FIG. 16 is a flow chart showing an example of the procedure for the gradual shift map updating process in FIG. 15.

### DETAILED DESCRIPTION OF THE PREFERRED EMBODIMENTS

With reference now to the attached drawings, embodiments of the present invention will be explained in detail below.

(Embodiment 1)

This embodiment will explain a picture coding apparatus and picture decoding apparatus to which a moving picture coding method capable of improving picture quality of an important area preferentially even in a low bit rate and gradually improving also picture quality of neighboring areas as the bit rate becomes higher.

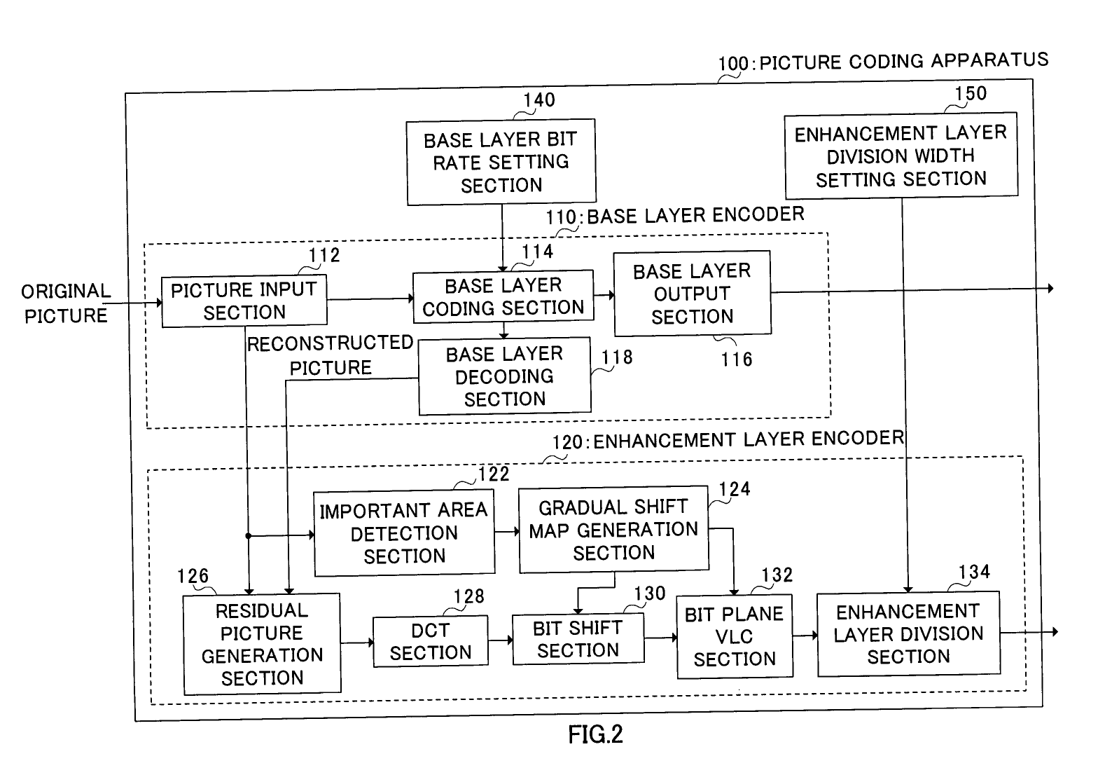

FIG. 2 is a block diagram showing a configuration of a picture coding apparatus to which a moving picture coding method according to Embodiment 1 of the present invention is applied.

The picture coding apparatus 100 shown in FIG. 2 comprises a base layer encoder 110 that generates a base layer, an enhancement layer encoder 120 that generates an enhancement layer, abase layer bit rate setting section 140 that sets a bit rate of a base layer and an enhancement layer division width setting section 150 that sets a division bit rate of the enhancement layer.

The base layer encoder 110 comprises a picture input section 112 that inputs one picture (original picture) at a time, a base layer coding section 114 that performs compression/coding on the base layer, a base layer output section 116 that outputs the base layer and a base layer decoding section 118 that decodes the base layer.

The enhancement layer encoder 120 comprises an important area detection section 122 that detects an important area, a gradual shift map generation section 124 that generates a gradual shift map from information on the important area, a residual picture generation section 126 that creates a residual picture between the input picture and the base layer decoded picture (reconstructed picture), a DCT section 128 that performs a DCT transform, a bit shift section 130 that performs a bit shift of a DCT coefficient according to a shift map output from the gradual shift map generation section 124, a bit plane VLC section 132 that performs variable length coding (VLC) on the DCT coefficient for each bit plane and an enhancement layer division section 134 that performs data division processing on the VLC-coded enhancement layer with a division width input from the enhancement layer division width setting section 150.

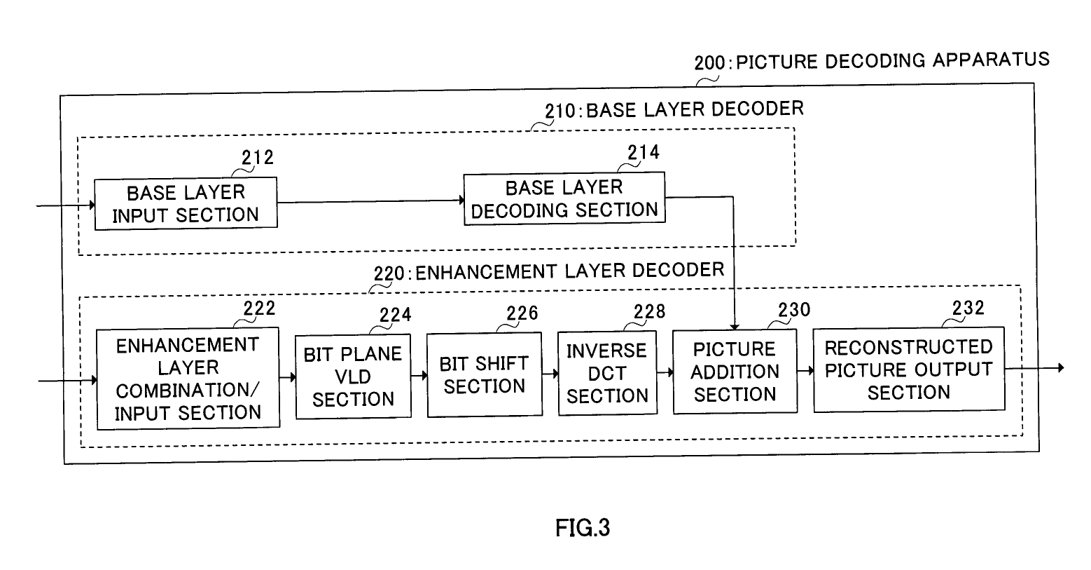

FIG. 3 is a block diagram showing a configuration of a picture decoding apparatus to which the moving picture coding method according to Embodiment 1 of the present invention is applied.

The picture decoding apparatus 200 shown in FIG. 3 comprises a base layer decoder 210 that decodes a base layer and an enhancement layer decoder 220 that decodes an enhancement layer.

The base layer decoder 210 comprises a base layer input section 212 that inputs a base layer and a base layer decoding section 214 that performs decoding processing on the input base layer.

The enhancement layer decoder 220 comprises an enhancement layer combination input section 222 that combines a plurality of divided enhancement layers and inputs them, a bit plane VLD section 224 that performs bit plane VLD (Variable Length Decoding) processing on the enhancement layer, a bit shift section 226 that performs a bit shift, an inverse DCT section 228 that performs inverse DCT processing, a picture addition section 230 that adds up the base layer decoded picture and the enhancement layer decoded picture and a reconstructed picture output section 232 that outputs the reconstructed picture.

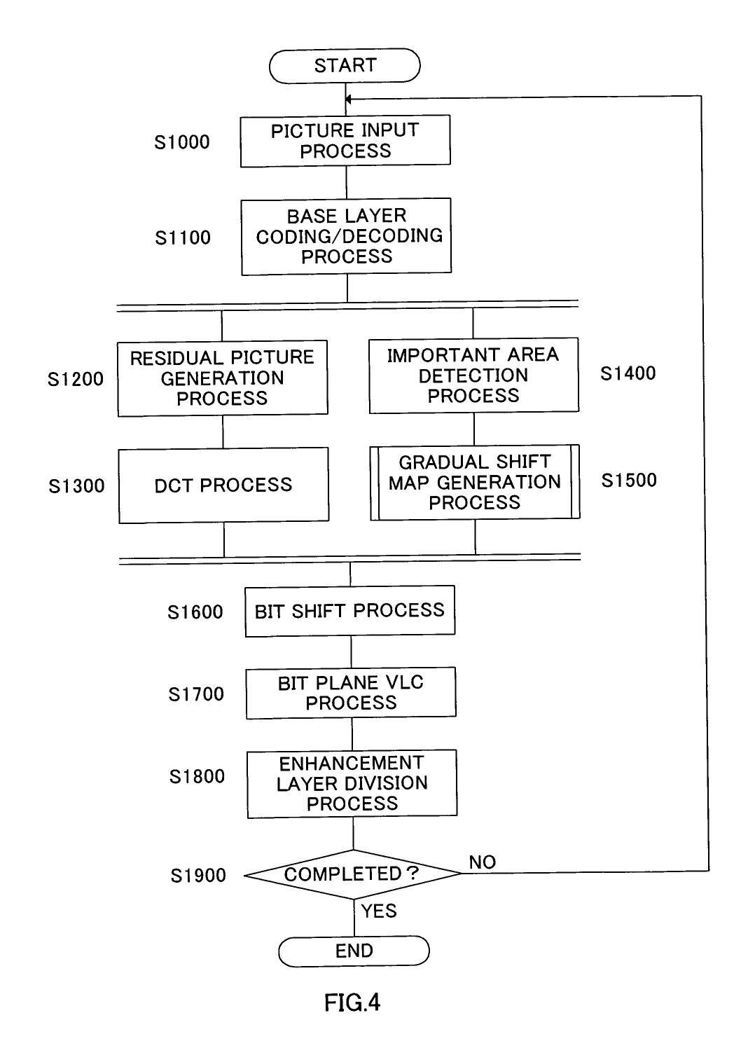

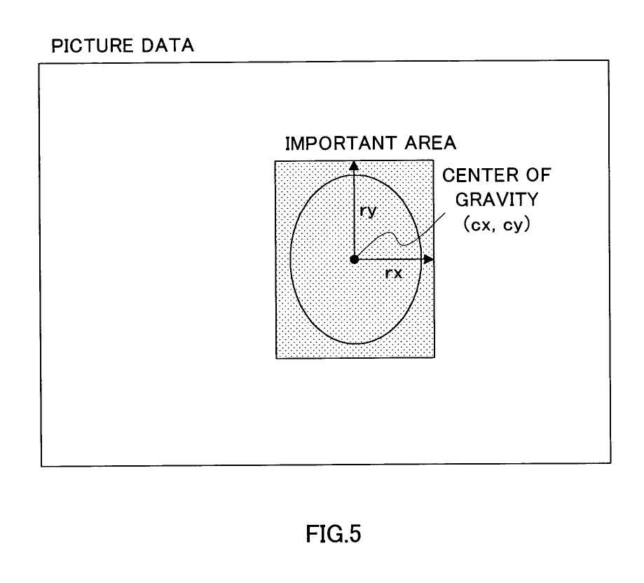

Then, the operation of the picture coding apparatus 100 having the above described configuration, that is, the procedure for processes on a picture signal at the picture coding apparatus 100 will be explained using the flow chart shown in FIG. 4. The flow chart shown in FIG. 4 is stored as a control program in a storage apparatus (not shown, e.g., ROM and flash memory) of the picture coding apparatus 100 and executed by a CPU (not shown).

First in step S1000, a picture input process of imputing a picture signal is performed. More specifically, the picture input section 112 detects a sync signal from the input picture signal and outputs an original picture making up the picture signal to the base layer coding section 114, residual picture generation section 126 and important area detection section 122 for each frame. Furthermore, the base layer bit rate setting section 140 outputs a bit rate value corresponding to the base layer to the base layer coding section 114 and the enhancement layer division width setting section 150 outputs the division size of the enhancement layer to the enhancement layer division section 134.

Then, in step S1100, a base layer coding/decoding process of coding/decoding the picture signal as the base layer is performed. More specifically, the base layer coding section 114 performs MPEG coding using motion compensation, DCT, quantization or variable length coding processing, etc., on the original picture input from the picture input section 112 so that the original picture has the bit rate input from the base layer bit rate setting section 140, generates a base layer stream and outputs the stream generated to the base layer output section 116 and base layer decoding section 118. Then, the base layer output section 116 outputs the base layer stream input from the base layer coding section 114 to the outside. Furthermore, the base layer decoding section 118 performs MPEG decoding on the base layer stream input from the base layer coding section 114, generates a decoded picture (reconstructed picture) and outputs the decoded picture generated to the residual picture generation section 126.

Then, in step S1200, a residual picture generation process of calculating a residual picture is performed. More specifically, the residual picture generation section 126 performs residual processing on the original picture input from the picture input section 112 finding a residue from the decoded picture input from the base layer decoding section 118 for each pixel, generates a residual picture and outputs the residual picture generated to the DCT section 128.

Then, in step S1300, a DCT transform process of DCT-transforming the residual picture is performed. More specifically, the DCT section 128 applies a discrete cosine transform (DCT) to the entire picture of the residual picture input from the residual picture generation section 126 in units of 8×8 pixels, calculates a DCT coefficient of the entire picture and outputs the DCT coefficient obtained to the bit shift section 13Q.

On the other hand, in step S1400, an important area detection process of detecting an important area is performed. More specifically, the important area detection section 122 detects, for example, an area of the picture data of one frame input from the picture input section 112 where there is a high correlation with the prestored picture data such as an average face picture. Here, according to the degree of correlation, the degree of relative importance is determined. Then, the area with the highest correlation (that is, the area with the highest degree of importance) is regarded as the important area and the detection result thereof is output to the gradual shift map generation section 124.

FIG. 5 illustrates an example of the detection result at the important area detection section 122. Here, when for example, a rectangular area is output as the detection result, suppose four values of coordinates (cx, cy) of the center of gravity and the radius (rx, ry) from the center of gravity G in the horizontal and vertical directions of the important area are output.

The method of outputting the detection result at the important area detection section 122 is not limited to this and any output method is available if it can at least specify the area. Moreover, the method of detecting an important area is not limited to the one using a correlation with the picture but any technique is available if it can at least detect the area. Furthermore, the important area detection section 122 is not limited to the method of detecting a face area but any method is available if it can at least detect or specify an area important to the user. For example, as the method of detecting an important area, it is also possible to detect a moving object in addition to the face area in the moving picture, together with the face area or selectively. This allows the degree of importance to be set more efficiently.

Then, in step S1500, a gradual shift map generation process of generating a gradual shift map is performed. More specifically, the gradual shift map generation section 124 generates a gradual shift map having gradual shift values using four pieces of information of coordinates (cx, cy) of the center of gravity and the radius (rx, ry) of the area input from the important area detection section 122 and outputs the gradual shift map generated to the bit shift section 130. The gradual shift map is a map which shows the picture with one value for each macro block of 16×16 square pixels.

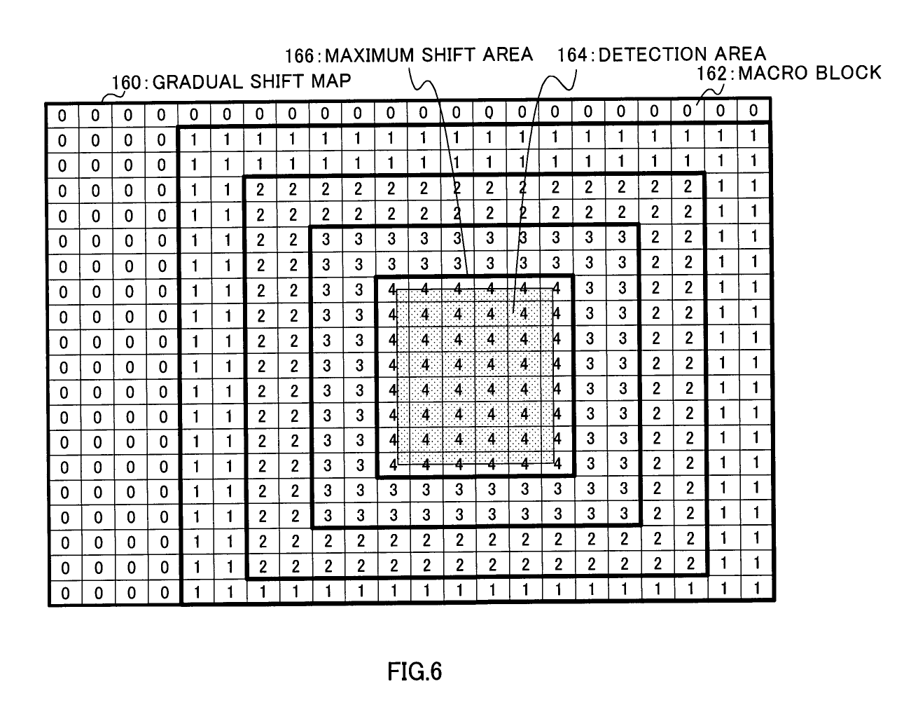

FIG. 6 illustrates an example of a gradual shift map. The gradual shift map 160 shown in FIG. 6 divides a picture into macro blocks 162 and each macro block 162 has one shift value. Here, as shown in FIG. 6, the number of step of a shift value is 5 from “0” to “4” and a detection area 164 detected by the important area detection section 122 has the largest shift value and the shift value decreases toward the neighboring area.

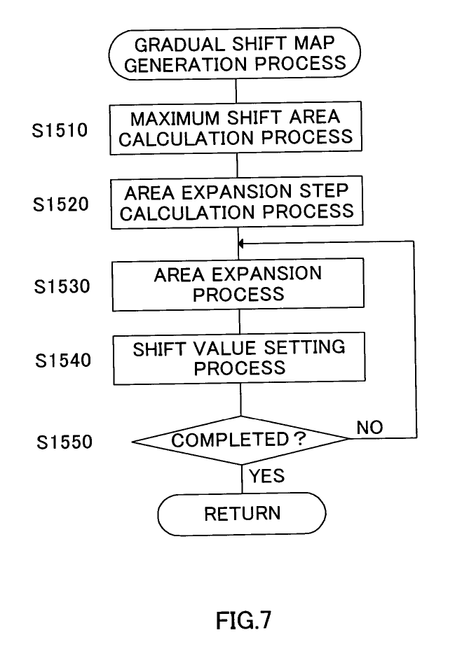

FIG. 7 is a flow chart illustrating an example of the procedure for the gradual shift map generation process in FIG. 4. This gradual shift map generation process consists of four processes as shown in FIG. 7; maximum shift area calculation process (step S1510), area expansion step calculation process (step S1520), area expansion process (step S1530) and shift value setting process (step S1540).

First, in step S1510, a maximum shift area calculation process is performed. More specifically, the gradual shift map generation section 124 regards the macro block area made up of macro blocks including the area input from the important area detection section 122 as a maximum shift area 166 (see FIG. 6), sets a maximum value among shift values for all the macro blocks in this maximum shift area 166 and sets “0” for other areas. In the example shown in FIG. 6, since the shift values are set to “0” to “4”, a maximum value “4” is shown inside the maximum shift area 166. Hereafter, an area whose shift value is set to any value other than “0” will be called a “non-zero shift area.”

Then, in step S1520, an area expansion step calculation process is performed. More specifically, the gradual shift map generation section 124 expands the area from a specific important area to the neighboring area and calculates an area expansion step used when a small shift value is set using the radius (rx, ry) of the important area input from the important area detection section 122. The area expansion step is calculated using, for example, following Expression 1 and Expression 2.

$$\begin{matrix}dx = \frac{rx}{2 * macroblock\_size} & ( Expression 1 ) \\ dy = \frac{ry}{2 * macroblock\_size} & ( Expression 2 )\end{matrix}$$

In Expression 1, dx denotes a horizontal expansion step (macro block unit), rx denotes a horizontal radius of the detection area 164 (pixel unit) and macroblock_size denotes the horizontal width of a macro block (macro block unit). Furthermore, in Expression 2, dy denotes a vertical expansion step (macro block unit) and ry denotes a vertical radius of the detection area 164 (pixel unit).

Then, in step S1530, an area expansion process is performed. More specifically, the gradual shift map generation section 124 expands the current non-zero shift area by dx macro block columns in the horizontal direction and expands it by dy macro block rows in the vertical direction using the area expansion steps dx and dy calculated from Expression 1 and Expression 2 above with the center of gravity G as a common factor. However, in such an expansion process, the expansion process is stopped in a direction in which the expanded area extends beyond the frame.

Then, in step S1540, a shift value setting process is performed. More specifically, the gradual shift map generation section 124 sets a value obtained by subtracting “1” from a minimum shift value in the non-zero shift area in the area expanded through the area expansion process in step S1530.

Then, in step S1550, it is decided whether the gradual shift map generation process is completed or not. More specifically, it is decided whether the shift value set in step S1540 is “0” or not. As a result of this decision, if the shift value set in step S1540 is “0” (S1550: YES), the process returns to the flow chart in FIG. 4 and if the shift value set in step S1540 is not “0” (S1550: NO), the process returns to step S1530. That is, until the shift value set in step S1540 becomes “0” step S1530 (area expansion process) and step S1540 (shift value setting process) are repeated and the gradual shift map generation process is completed. Then, the gradual shift map obtained is output to the bit shift section 130.

The method of generating the gradual shift map is not limited to the method of gradual expansion using the radius of the detection area 164, but any method is available if it at least has a tendency that a shift value decreases gradually from the important area to the neighboring area.

Then, in step S1600, a bit shift process of carrying out a bit shift on a DCT coefficient is performed. More specifically, the bit shift section 130 carries out a bit shift on the DCT coefficient input from the DCT section 128 for each macro block using the shift value in the gradual shift map input from the gradual shift map generation section 124. For example, for a macro block whose shift value is “4”, all DCT coefficients in the macro block are shifted by 4 bits in the higher bit direction.

FIG. 8A to FIG. 8D illustrate examples of bit shifts; FIG. 8A illustrates a gradual shift map, FIG. 8B illustrates DCT coefficients of MB1, FIG. 8C is a conceptual diagram of a bit plane before a bit shift and FIG. 8D is a conceptual diagram of a bit plane after a bit shift.

Here, the gradual shift map shown in FIG. 8A is a gradual shift map having shift values for 5×4 macroblocks, MB1 indicates a shift value of the macro block 1, MB2 indicates a shift value of the macro block 2 and MB3 indicates a shift value of the macro block 3. The DCT coefficients of MB1 shown in FIG. 8B express the DCT coefficients included in the macro block 1 (MB1) in binary numbers. Furthermore, the conceptual diagram of a bit plane before a bit shift shown in FIG. 8C schematically shows all DCT coefficients included in MB1 to MB3 arranged with the vertical axis expressing the bit plane and the horizontal axis expressing the positions of DCT coefficients. The bit plane conceptual diagram after a bit shift shown in FIG. 8D shows DCT coefficients after carrying out a bit shift in the higher direction for each macro block based on the shift values shown in the gradual shift map in FIG. 8A.

Thus, the bit shift process carries out a bit shift on DCT coefficients according to the gradual shift map generated in step S1500 and then outputs the DCT coefficients after bit shift to the bit plane VLC section 132.

Then, in step S1700, a bit plane VLC process of VLC-processing each bit plane is performed. More specifically, the bit plane VLC section 132 performs variable length coding on the gradual shift map input from the gradual shift map generation section 124 and further carries out variable length coding on the DCT coefficients input from the bit shift section 130 for each bit plane.

FIG. 9 is a conceptual diagram of a bit plane VLC and corresponds to the bit plane conceptual diagram after a bit shift shown in FIG. 8D. However, in FIG. 9, the first bit plane is a plane collecting bits located at MSB (Most Significant Bit) positions when all DCT coefficients within a frame are arranged in order of bit planes, the second bit plane is a plane collecting bits located at higher bit positions next to the MSB, the third bit plane is a plane collecting bits located at higher bit positions next to the second bit plane and the Nth bit plane is a plane collecting bits located at the position of the LSB (Least Significant Bit).

FIG. 10 is a configuration diagram of an enhancement layer bit stream. The enhancement layer bit stream shown in FIG. 10 is the bit stream generated by carrying out variable length coding on each bit plane and stored in the order of the first bit plane (bp1), second bit plane (bp2), . . . , Nth bit plane (bpN).

The bit plane VLC section 132 performs variable length coding on the bit string which exists on the first bit plane out of the entire picture first and then places the bit stream generated at the start position of the enhancement layer (bp1). Then, the bit plane VLC section 132 performs variable length coding on the second bit plane and places it at the position next to the bit stream of the first bit plane (bp2). Then, it repeats the same procedure and finally performs variable length coding on the Nth bit plane and places it at the final position of the bit stream (bpN). Furthermore, suppose that all lower bits generated by bit shifts are handled as a “0” binary value. In this way, macro blocks bit-shifted with a larger value are variable-length coded on a higher bit plane and stored closer to the start position in a moving picture stream which becomes an enhancement layer.

Thus, the bit plane VLC process carries out bit plane VLC and generates a moving picture stream which becomes an enhancement layer. The moving picture stream generated is output to the enhancement layer division section 134.

FIG. 11A illustrates an example of a result of detection of an important area and FIG. 11B illustrates an example of the corresponding gradual shift map. FIG. 12 illustrates an example of the corresponding bit shift result.

Here, the gradual shift map shown in FIG. 11B is an example of a map having a shift value for each macro block 162 and a maximum shift value “2” is set in the macro blocks including the important area 164 and shift values are gradually decreased in the neighboring areas, where “1” and “0” are set.

The bit shift result shown in FIG. 12 expresses DCT coefficients of one entire frame three-dimensionally using the x-axis, y-axis and bit plane as the axes and shows the result of bit shifts carried out on each macro block using shift values shown in the gradual shift map. In this bit shift result, the important area 164 is located on the most significant bit plane and the neighboring areas are located on the next bit planes, and therefore in the variable length coding process carried out from the higher bit plane, variable length coding is performed sequentially from the important area 164 to the neighboring area and the moving picture stream which becomes an enhancement layer is stored with the start position therein first. For simplicity, FIG. 12 illustrates the bit shift result assuming that all the higher bits of the DCT coefficients within the frame are located on the same bit plane.

Then, in step S1800, an enhancement layer division process of dividing the enhancement layer into a plurality of portions is performed. More specifically, the enhancement layer division section 134 divides data from the start position of the enhancement layer input from the bit plane VLC section 132 using the division size input from the enhancement layer division width setting section 150 and outputs the plurality of divided enhancement layer portions to the outside. The divided enhancement layer is transmitted with the plurality of portions from the start portion combined into one according to the transmission bit rate and it is thereby possible to control the bit rate of the picture data.

Then, in step S1900, an end decision process is performed. More specifically, it is decided whether the picture input section 112 has stopped the input of a picture signal or not. When this decision result shows that the picture input section 112 has stopped the input of a picture signal (S1900: YES), it is decided that the coding has ended and a series of coding processes is completed. When the picture input section 112 has not stopped the input of a picture signal (S1900: NO), the process moves back to step S1000. That is, the series of processes from step S1000 to step S1800 is repeated until the picture input section 112 stops the input of a picture signal.

Then, the operation of the picture decoding apparatus 200 having the above described configuration, that is, the procedure of processes on a bit stream by the picture decoding apparatus 200 will be explained using the flow chart shown in FIG. 13. The flow chart shown in FIG. 13 is stored as a control program in a storage apparatus (e.g., ROM and flash memory, etc.) (not shown) of the picture decoding apparatus 200 and executed by a CPU (not shown).

First, in step S2000, a decoding start process of starting decoding of each picture is performed. More specifically, the base layer input section 212 starts a base layer input process and the enhancement layer combination input section 222 starts an enhancement layer input process.

Then, in step S2100, a base layer input process of inputting the base layer is performed. More specifically, the base layer input section 212 extracts a base layer stream per one frame and outputs it to the base layer decoding section 214.

Then, in step S2200, a base layer decoding process of decoding the base layer is performed. More specifically, the base layer decoding section 214 carries out an MPEG decoding process such as VLD, inverse quantization, inverse DCT and motion compensation on the base layer stream input from the base layer input section 212, generates a base layer decoded picture and outputs the base layer decoded picture generated to the picture addition section 230.

On the other hand, in step S2300, an enhancement layer combination input process of combining and inputting a plurality of enhancement layers is performed. More specifically, the enhancement layer combination input section 222 combines the divided enhancement layer portions into one from the start portion and outputs a combined enhancement layer stream to the bit plane VLD section 224. The number of the divided enhancement layer portions varies depending on conditions such as a transmission bit rate.

Then, in step S2400, a bit plane VLD process of VLD-processing each bit plane is performed. More specifically, the bit plane VLD section 224 carries out a variable length decoding (VLD) process on the enhancement layer bit stream input from the enhancement layer combination input section 222, calculates DCT coefficients and a gradual shift map of the entire frame and outputs the calculation result to the bit shift section 226.

Then, in step S2500, a bit shift process of carrying out a bit shift on the DCT coefficient after VLD is performed. More specifically, the bit shift section 226 performs a bit shift on the DCT coefficients input from the bit plane VLD section 224 for each macro block in the lower bit direction according to the shift values shown in the gradual shift map and outputs the DCT coefficients after the bit shift to the inverse DCT section 228.

Then, in step S2600, an inverse DCT process is performed. More specifically, the inverse DCT section 228 carries out an inverse DCT process on the DCT coefficients input from the bit shift section 226, generates a decoded picture of the enhancement layer and outputs the enhancement layer decoded picture generated to the picture addition section 230.

Then, in step S2700, a picture addition process of adding up the decoded picture of the base layer and the decoded picture of the enhancement layer is performed. More specifically, the picture addition section 230 adds up the decoded picture of the base layer input from the base layer decoding section 214 and the decoded picture of the enhancement layer input from the inverse DCT section 228 for each pixel, generates a reconstructed picture and outputs the reconstructed picture generated to the reconstructed picture output section 232. Then, the reconstructed picture output section 232 outputs the reconstructed picture input from the picture addition section 230 to the outside.

Then, in step S2800, an end decision process is performed. More specifically, it is decided whether the base layer input section 212 has stopped the input of abase layer stream or not. When the decision result shows that the base layer input section 212 has stopped the input of a base layer stream (S2800: YES), it is decided that decoding has finished and a series of decoding processes is completed. When the base layer input section 212 has not stopped the input of a base layer stream (S2800: NO), the process moves back to step S2000. That is, the series of processes from step S2000 to step S2700 is repeated until the base layer input section 212 stops the input of a base layer stream.

Thus, according to this embodiment, the picture coding apparatus 100 comprises the important area detection section 122 that automatically detects an important area within the frame, the gradual shift map generation section 124 that generates a gradual shift map whose shift value decreases gradually from the important area to the neighboring area and the bit shift section 130 that carries out a bit shift on the DCT coefficient according to the gradual shift map, and can thereby store more DCT coefficients that contribute to improvement of the picture quality of the important area preferentially in the start portion of the enhancement layer and improve the picture quality of the important area preferentially even in a low bit rate where there is a smaller amount of enhancement layer data.

Furthermore, according to this embodiment, the shorter the distance from the important area, the closer to the start of the enhancement layer DCT coefficients which contribute to improvement of the picture quality can be stored, and it is possible to include DCT coefficients which contribute to improvement of the picture quality in a wider neighboring area in the enhancement layer as the bit rate becomes higher by increasing the amount of data of the enhancement layer, and it is thereby possible to gradually expand areas whose picture quality is to be improved. Therefore, as the bit rate expands, it is possible to improve the picture quality of the area which has been expanded a great deal over the entire frame centered on the important area.

This embodiment uses an MPEG system for coding/decoding of a base layer and uses an MPEG-4 FGS system for coding/decoding of an enhancement layer, but the present invention is not limited to these systems and any other coding/decoding system can also be used if it is a system which at least uses bit plane coding.

Furthermore, this embodiment carries out coding of a base layer/enhancement layer asynchronously with a transfer of picture data, but synchronizing coding with a transfer will make it possible to perform coding of a user-specified important area preferentially and transfer live pictures more efficiently.

(Embodiment 2)

This embodiment will describe a picture coding apparatus which applies a moving picture coding method capable of improving picture quality in an area in which picture quality of its base layer deteriorates considerably and which constitutes an important area even in a low bit rate, and also gradually improving picture quality of neighboring areas as the bit rate becomes higher.

FIG. 14 is a block diagram showing a configuration of a picture coding apparatus to which a moving picture coding method according to Embodiment 2 of the present invention is applied. This picture coding apparatus 300 has a configuration similar to that of the picture coding apparatus 100 in FIG. 2 and the same components are assigned the same reference numerals and explanations of detailed process thereof will be omitted.

A feature of this embodiment is that an enhancement layer encoder 120a is provided with an additional function which will be described later. That is, as with the picture coding apparatus 100 shown in FIG. 2, the picture coding apparatus 300 comprises a gradual shift map generation section 124a that codes a picture signal into a base layer and enhancement layer and generates a gradual shift map from important area information and a residual picture generation section 126a that generates a residual picture between the input picture and base layer decoded picture, and the residual picture generated by the residual picture generation section 126a is also output to the gradual shift map generation section 124a.

The residual picture generation section 126a carries out residual processing with respect to a decoded picture (reconstructed picture) input from the base layer decoding section 118 on an original picture input from the picture input section 112 for each pixel, generates a residual picture, adds the residual picture generated to the DCT section 128 and also outputs it to the gradual shift map generation section 124a.

The gradual shift map generation section 124a generates a gradual shift map having gradual shift values using four pieces of information of coordinates of the center of gravity (cx, cy) and the radius (rx, ry) of the area input from the important area detection section 122 and the residual picture input from the residual picture generation section 126a.

FIG. 15 is a flow chart showing an example of the procedure for a gradual shift map generation process by the gradual shift map generation section 124a. Here, as shown in FIG. 15, step S1545 is inserted into the flow chart shown in FIG. 7.

Step S1510 to step S1540 are the same as the corresponding steps in the flow chart shown in FIG. 7, and therefore explanations thereof will be omitted.

Then, in step S1545, shift values of the gradual shift map calculated through the processes in step S1510 to step S1540 are updated using the residual picture. That is, the gradual shift map generation section 124a calculates the gradual shift map through the processes in step S1510 to step S1540 and then updates the shift values of the gradual shift map using the residual picture.

FIG. 16 is a flow chart showing an example of the procedure for the gradual shift map updating processing in FIG. 15. As shown in FIG. 16, this gradual shift map updating processing consists of three processes; a residual absolute sum calculation process (step S3000) a preferential macro block calculation process (step S3100) and a shift map updating process (step S3200).

First, in step S3000, the residual absolute sum calculation process is performed. More specifically, the gradual shift map generation section 124a calculates SUM(i) which is the sum of absolute values of pixels in a macro block for each macro block i using the residual picture input from the residual picture generation section 126a. The residual absolute sum is calculated using, for example, Expression 3 below.

$$SUM ( i ) = {\sum }_{j = 1}^{N} \vert DIFF ( j ) \vert \qquad ( Expression 3 )$$

Here, i denotes the position of a macro block, SUM(i) denotes the sum of absolute values of pixels in the macro block i, j denotes the position of a pixel in the macro block, N denotes the total number of pixels in the macro block and DIFF(j) denotes the pixel value of a pixel j.

Then, in step S3100, a preferential macro block calculation process is performed. More specifically, the gradual shift map generation section 124a calculates an average value AVR (shift) of the residual absolute sum SUM(i) for each area having the same shift value, shift, in the gradual shift map. Then, the gradual shift map generation section 124a compares the residual absolute sum SUM(i) of each macro block i with the average value AVR (shift) for each area having the same shift value, shift. Then, this comparison result shows that when the residual absolute sum SUM(i) is greater than the average value AVR (shift), this macroblock is regarded as a preferential macro block.

Here, the average value AVR (shift) is calculated using, for example, Expression 4 below.

$$AVR ( shift ) = \frac{{\sum }_{k = 1}^{M} SUM\_shift ( k )}{M} \qquad ( Expression 4 )$$

In Expression 4, AVR (shift) denotes an average value of the residual absolute sum of a macro block whose shift value is “shift” in the gradual shift map, M denotes the number of macro blocks whose shift value is “shift” in the gradual shift map and SUM_shift(k) denotes the residual absolute sum of macro block k whose shift value is “shift”.

Furthermore, the preferential macro block is calculated using, for example, Expression 5 below.

If (SUM_shift(i)>AVR (shift)) then MBi=“Preferential Macro Block” (Expression 5)

Here, MBi denotes a macro block i.

The method of calculating the preferential macro block is not limited to Expression 5 and any method can be used if it at least allows a macro block having a large residual absolute sum to become a preferential macro block.

Then, in step S3200, a shift map updating process is performed. More specifically, the gradual shift map generation section 124a adds “1” to the shift value shown in the gradual shift map for the preferential macro block calculated by the preferential macro block calculation process in step S3100 and then returns to the flow chart in FIG. 15.

The shift map updating method is not limited to the method of adding “1” to the shift value of the preferential macro block but any method is available if it at least increases the shift value.

Since step S1550 is the same as the step in the flow chart shown in FIG. 7, explanations thereof will be omitted.

In this way, the gradual shift map generation section 124a performs the gradual shift map updating process and outputs the gradual shift map obtained to the bit shift section 130.

In this way, according to this embodiment, in the gradual shift map updating process, the gradual shift map generation section 124a can preferentially carry out bit plane VLC on a macro block whose picture quality deterioration in a base layer is large to further increase shift values for macro blocks whose absolute sum of a residual picture is large and further preferentially improve picture quality of the part of an important area whose picture quality deterioration is large especially in a low bit rate.

As described above, the present invention can maintain high picture quality for an important area even in a low bit rate and gradually improve picture quality of the neighboring area as the bit rate becomes higher.

That is, the moving picture coding method of the present invention is a moving picture coding method which performs coding by dividing a moving picture into one base layer and at least one enhancement layer, comprising an extracting step of extracting the degree of importance of each area of the moving picture and an assigning step of assigning coded data of each area to the enhancement layers in descending order of the degree of importance of the areas.

According to this method, it is possible to transmit a moving picture code capable of decoding the area of a high degree of importance preferentially to even a moving picture receiving terminal whose transmission bit rate belongs to a low bit rate, maintain high picture quality for the important area even in a low bit rate and gradually improve picture quality of the neighboring area as the bit rate becomes higher.

Furthermore, the moving picture coding method of the present invention is adapted so as to regard the area having the highest degree of importance as an important area and decrease the degree of importance from the important area toward the neighboring area.

According to this method, it is possible to decode information which is more important to the user with higher priority and encodes picture data more effectively.

Furthermore, the moving picture coding method of the present invention is adapted so as to extract the degree of importance by detecting a face area or moving object in the moving picture.

According to this method, the degree of importance can be set more effectively.

Furthermore, the moving picture coding method of the present invention is adapted so as to further increase the degree of importance for the area inside the important area where there is a large residual value between the base layer decoded moving picture and the original moving picture.

According to this method, areas of an important area with drastic variations are preferentially stored in the enhancement layer and it is thereby possible to preferentially improve picture quality of areas inside the important area where deterioration of picture quality in the base layer is large and provide coded data more effectively.

Furthermore, the moving picture coding method of the present invention is adapted in such a way that in the assigning step, a shift value is set according to the degree of importance, a bit shift is performed on the coded data of each area by the corresponding shift value and the coded data of each area is assigned to the enhancement layer.

According to this method, it is possible to form an enhancement layer according to the priority which corresponds to the degree of importance.

Furthermore, the moving picture coding method of the present invention is adapted so as to set a greater shift value as the degree of importance increases.

According to this method, it is possible to store data of a high degree of importance in a higher enhancement layer and improve picture quality of areas with a high degree of importance preferentially during decoding.

Furthermore, the moving picture coding method of the present invention is adapted so as to carry out coding and transfer of a moving picture using any one of the above described moving picture coding methods synchronized with each other.

According to this method, the coding and transfer of a moving picture can be executed effectively synchronized with each other.

Furthermore, the moving picture coding apparatus of the present invention comprises a picture input section that inputs an original moving picture, a base layer coding section that extracts one base layer from the original moving picture and codes the base layer, a base layer decoding section that decodes the base layer coded by the base layer coding section and reconstructs the base layer, a residual picture generation section that generates a residual picture between the reconstructed picture reconstructed by the base layer decoding section and the original moving picture, an important area detection section that detects an important area from the original moving picture, a gradual shift map generation section that sets bit shift values gradually according to the degree of importance of the important area extracted by the important area detection section, a DCT section that DCT-transforms the residual picture generated by the residual picture generation section, a bit shift section that bit-shifts the DCT coefficient obtained by the DCT section by the bit shift value obtained by the gradual shift map generation section, a bit plane VLC section that performs VLC processing for each bit plane bit-shifted by the bit shift section and an enhancement layer division section that divides the moving picture stream VLC-processed by the bit plane VLC section as an enhancement layer into at least one portion.

According to this configuration, it is possible to transmit moving picture codes capable of decoding areas with a high degree of importance preferentially to even a reception terminal whose transmission bit rate belongs to a low bit rate, maintain high quality for the important area even in a low bit rate and gradually improve picture quality of the neighboring area as the bit rate becomes higher.

Furthermore, the moving picture coding program of the present invention is a program for causing a computer to execute the above described moving picture coding method.

According to this program, it is possible to transmit moving picture codes capable of decoding areas with a high degree of importance preferentially to even a reception terminal whose transmission bit rate belongs to a low bit rate, maintain high picture quality for the important area even in a low bit rate and gradually improve picture quality of the neighboring area as the bit rate becomes higher.

The present invention is not limited to the above described embodiments, and various variations and modifications may be possible without departing from the scope of the present invention.

This application is based on the Japanese Patent Application No.2002-295620 filed on Oct. 9, 2002, entire content of which is expressly incorporated by reference herein.

What is claimed is:

1. A moving picture coding method which performs coding by dividing a moving picture into one base layer and at least one enhancement layer, comprising:
an extracting step of extracting the degree of importance of each area of the moving picture; and
an assigning step of assigning coded data of each area to the enhancement layers in descending order of the degree of importance of the areas.

2. The moving picture coding method according to claim 1, wherein the area having the highest degree of importance is regarded as an important area and the degree of importance is decreased from said important area toward the neighboring area.

3. The moving picture coding method according to claim 1, wherein the degree of importance is extracted by detecting a face area or moving object in the moving picture.

4. The moving picture coding method according to claim 2, wherein the degree of importance is further increased for the area inside the important area where there is a large residual value between the base layer decoded moving picture and the original moving picture.

5. The moving picture coding method according to claim 1, wherein in said assigning step, a shift value is set according to the degree of importance, a bit shift is performed on the coded data of each area by the corresponding shift value and the coded data of each area is assigned to the enhancement layer.

6. The moving picture coding method according to claim 5, wherein a greater shift value is set as the degree of importance increases.

7. A moving picture transmission method which carries out coding and transfer of a moving picture using the moving picture coding method according to claim 1 synchronized with each other.

8. A moving picture coding apparatus comprising:
a picture input section that inputs an original moving picture;
a base layer coding section that extracts one base layer from said original moving picture and codes the base layer;
a base layer decoding section that decodes the base layer coded by said base layer coding section and reconstructs the base layer;
a residual picture generation section that generates a residual picture between the reconstructed picture reconstructed by said base layer decoding section and said original moving picture;
an important area detection section that detects an important area from said original moving picture;
a gradual shift map generation section that sets bit shift values gradually according to the degree of importance of the important area extracted by said important area detection section;
a DCT section that DCT-transforms the residual picture generated by said residual picture generation section;
a bit shift section that bit-shifts the DCT coefficient obtained by said DCT section by the bit shift value obtained by said gradual shift map generation section;
a bit plane VLC section that performs VLC processing for each bit plane bit-shifted by said bit shift section; and
an enhancement layer division section that divides the moving picture stream VLC-processed by said bit plane VLC section as an enhancement layer into at least one portion.

9. A program for causing a computer to execute the moving picture coding method according to claim 1.
